(19) United States
(12) Patent Application Publication
(10) Pub. No.: US 2012/0092171 A1
(43) Pub. Date: Apr. 19, 2012

(54) MOBILE DEVICE SLEEP MONITORING USING ENVIRONMENTAL SOUND

(75) Inventors: Kyuwoong Hwang, Daejeon (KR); Te-Won Lee, San Diego, CA (US); Kisun You, Suwon (KR); Taesu Kim, Seoul (KR)

(73) Assignee: QUALCOMM Incorporated, San Diego, CA (US)

(21) Appl. No.: 12/904,950

(22) Filed: Oct. 14, 2010

(51) Int. Cl. G08B 23/00

(52) U.S. Cl. 340/575

(57) ABSTRACT

A sleep monitoring application is installed on a mobile device. The mobile device is placed in a location when a user sleeps and records environmental sound. The sleep monitoring application determines indicators of sleep activity such as breathing sounds made by the user, and determines a sleep state of the user based on the indicators of sleep activity. Sleep disorders can be detected from the indicators of sleep activity. The sleep monitoring application may generate a report that summarizes the user's sleep states and alerts the user to any sleep disorders. The sleep monitoring application can use the environmental sound and the determined sleep states to determine ambient sound that is associated with good sleep. Later, if the sleep application determines the user is having problems sleeping, the sleep monitoring application can play the determined ambient sound to help the user sleep.

### BACKGROUND

Sleep is an important part of a healthy lifestyle. Getting an adequate amount of sleep each night has been shown to provide numerous benefits to both the mental health and the physical health of individuals. Moreover, sleep disorders such as snoring and apnea can lead to a variety of health disorders including death.

As can be expected, numerous devices have been developed to help users get better sleep and diagnose sleep disorders. Typically, these devices are attached to the user using a variety of sensors and take measurements while the user sleeps. For example, one such device attaches to the user's abdomen using a strap and measures a variety of sleep indicators such as heart rate, breathing rate, and body position. Another device requires the user to wear a specialized head gear that measures similar sleep indicators. In addition, many of these devices are expensive and may require a doctor or other professional to retrieve and analyze the data gathered by the devices.

While the existing devices are effective at diagnosing sleep disorders, they have many drawbacks. The use of head gear or other sensors attached to the user may make sleep difficult for the user, leading to inaccurate results or an exacerbation of existing sleep problems. Further, the expense of the devices and need for a professional to interpret the data gathered by the devices may make the devices and their use out of reach for many individuals. In addition, while the devices described above may help diagnose sleep disorders, they do not help the user actually get to sleep.

### SUMMARY

A sleep monitoring application is installed on a mobile device. The mobile device is placed in a location, such as a room, when a user sleeps and records environmental sound at the location (e.g., from the room). Using the environmental sound, the sleep monitoring application determines indicators of sleep activity such as breathing sounds made by the user. The sleep monitoring application determines a sleep state of the user based on the indicators of sleep activity. In addition, one or more sleep disorders can be detected from the indicators of sleep activity. The sleep monitoring application can generate a report for a user that summarizes the user's sleep states and alerts the user to any sleep disorders. Further, the sleep monitoring application can use the environmental sound and the determined sleep states to determine ambient sound (e.g., sounds in the room such as background sounds that are not made by the user) that is associated with good sleep. At a later time, if the sleep application determines the user is having problems sleeping, the sleep monitoring application can play the determined ambient sound to soothe the user to sleep.

In an implementation, environmental sound is collected at a mobile device. The environmental sound is analyzed by the mobile device to determine one or more indicators of sleep activity. The one or more indicators of sleep activity are processed by the mobile device to identify one or more sleep cycles. A sleep report is generated by the mobile device using the identified one or more sleep cycles.

Implementations may include some or all of the following features. Analyzing the environmental sound to determine indicators of sleep activity may use one or more sound models. The sound models may include a hidden Markov model trained or decoded using a Viterbi algorithm. The indicators of sleep activity may include sound associated with breathing and sound associated with body movement. The environmental sound may be analyzed to determine ambient sound. The ambient sound may be correlated with the one or more sleep cycles to identify ambient sound associated with good sleep. Whether a user is not asleep may be determined using the one or more identified sleep cycles, and if it is determined that the user is not asleep, the identified ambient sound may be caused to play. Causing the identified ambient sound to play may include causing the mobile device to play the ambient sound and/or causing an electronic device external to the mobile device to play the ambient sound. Whether a user is asleep may be determined using the one or more identified sleep cycles, and if it is determined that the user is asleep, one or more electronic devices may be disabled. One or more indicators of sleep activity may be processed to identify one or more sleep disorders by the mobile device. Whether a user is about to wake up is determined using the one or more identified sleep cycles, and if it is determined that the user is about to wake up, one or more electronic devices may be enabled. The one or more electronic devices may include a television, a radio, and/or a lighting device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is an illustration of an example environment for collecting environmental sound and generating a sleep report using the environmental sound;

FIG. 2 is an illustration of an example mobile device with a sleep monitoring application;

FIG. 3 is an illustration of an example mobile device with a sleep monitoring application in communication with a sleep monitoring server;

FIG. 4 is an illustration of an example state machine used to identify an indicator of sleep activity;

FIG. 5 is an illustration of an example state machine used to identify one or more sleep states;

FIG. 6 is an illustration of an example state machine used to identify one or more sleep disorders;

FIG. 7 is an operational flow of an implementation of a method for generating a sleep report based on collected environmental sound;

FIG. 8 is an operational flow of an implementation of a method for determining ambient sound associated with one or more sleep cycles and playing the determined ambient sound to a user when it is determined that the user is having difficulty sleeping;

FIG. 9 is an operational flow of an implementation of a method for determining if a user is asleep and deactivating one or more electronic devices if the user is asleep;

FIG. 10 is an operational flow of an implementation of a method for determining is a user is going to wake up and activating one or more electronic devices if the user is going to wake up;

FIG. 11 is an illustration of an example sleep report; and

FIG. 12 shows a block diagram of a design of an example mobile device in a wireless communication system.

### DETAILED DESCRIPTION

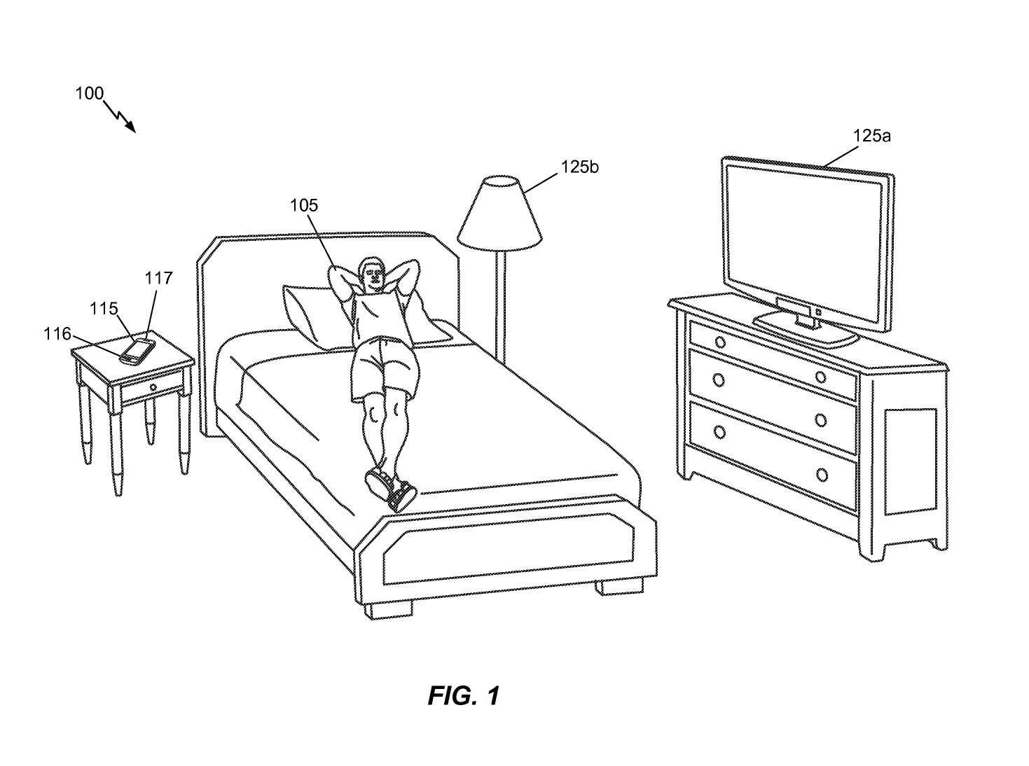

FIG. 1 is an illustration of an example environment 100 for collecting environmental sound and generating a sleep report using the environmental sound. The environment 100 may include a mobile device 115. The mobile device 115 may include a microphone 116 and a speaker 117. In some implementations, the microphone 116 and/or the speaker 117 are built into the mobile device 115 and may be used for making phone calls using the mobile device 115. Alternatively, the microphone 116 and/or speaker 117 may be part of one or more separate components that interface with the mobile device 115. For example, the one or more components may include a microphone and/or a speaker that are of a higher fidelity or sensitivity than the microphone 116 and/or speaker 117 that are included with the mobile device 115.

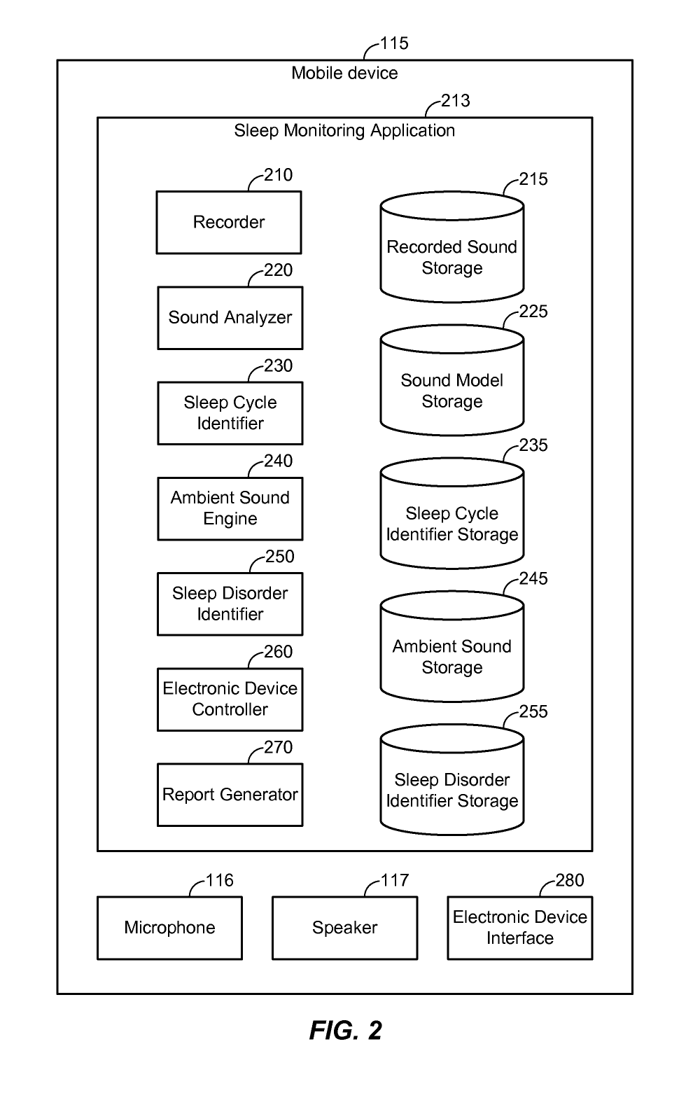

As described further with respect to FIG. 2 for example, the mobile device 115 may execute a sleep monitoring application 213 that collects environmental sound while a user 105 sleeps. The user 105 may activate the sleep monitoring application 213 using the mobile device 115 and place the mobile device 115 proximate to a location where the user 105 is sleeping. As illustrated in FIG. 1, the user 105 has placed the mobile device 115 on a nightstand next to their bed. No sensors or other monitors are physically connected to the user 105. Moreover, the mobile device 115 does not have to be in the bed with the user 105, although the mobile device 115 may be placed in the bed if desired.

The sleep monitoring application 213 may collect and record environmental sound from the room using the microphone 116 while the user 105 sleeps. Environmental sound may include the sounds that are audible to the microphone 116. For example, environmental sound may include sounds made by user (breathing, snoring, stirring, teeth grinding, talking, crying, etc.), sounds originating in the room (radio or television sounds, heating and cooling related sounds, etc.), and sounds originating outside the room (traffic sounds, sounds from adjacent rooms, nature sounds, etc.).

The sleep monitoring application 213 may analyze the recorded environmental sound to determine indicators of sleep activity. The indicators of sleep activity may be used to determine if the user 105 is asleep or awake, what state of sleep (e.g., sleep cycle) the user 105 is likely in, and if the user 105 has any sleep disorders. The indicators of sleep activity may include the breathing rate of the user 105, sounds indicating the user 105 is snoring, and any sounds associated with restlessness or movement of the user 105. In some implementations, the indicators of sleep activity may be determined using one or more sound models, which may be previously trained.

The sleep monitoring application 213 may generate a report that summarizes the sleep activity of the user 105. The report may be displayed (e.g., to the user 105) on a display associated with the mobile device 115 and may summarize the sleep of the user 105 including how much sleep the user 105 received, how long the user 105 spent in each sleep cycle, and whether the user 105 may have any detected sleep disorders. The report may further include advice for the user 105 to get more or less sleep. The report may allow the user 105 to view sleep trends for a variety of time frames including weeks, months, and years, for example.

In addition to providing the user 105 with information related to the amount and quality of sleep that the user 105 is getting, the sleep monitoring application 213 may further determine when the user 105 is having problems achieving sleep and may help the user 105 fall asleep. The sleep monitoring application 213 may achieve this by analyzing the recorded environmental sound to determine what is referred to herein as “ambient sound.” The ambient sound is environmental sound that is not attributable to the user 105. For example, the ambient sound may include traffic sounds, clock ticking sounds, fan sounds, and other sounds.

The sleep monitoring application 213 may correlate the determined ambient sound with one or more sleep cycles to determine the particular ambient sound that is associated with good sleep of the user 105. This ambient sound may then be played back to the user 105 through the speaker 117 when it is determined that the user 105 is having trouble sleeping.

For example, the user 105 may normally sleep in a room with a loud clock. The sleep monitoring application 213 may correlate the ambient sound of the loud clock with the sleep states of the user 105. At a later time, the user 105 may be sleeping or attempting to sleep (e.g., in the room or elsewhere such as in a hotel or other foreign environment), and the sleep monitoring application 213 may determine the user 105 is not asleep after some threshold time. The sleep monitoring application 213 may then play the ambient sound of the loud clock to the user 105 through the speaker 117 to help the user 105 fall asleep.

As another feature, the sleep monitoring application 213 may control one or more electronic devices such as a television 125a and lighting 125b illustrated in FIG. 1 to provide a better sleep experience for the user 105. For example, the sleep monitoring application 213 may turn off the television 125a and/or the lighting 125b after the sleep monitoring application 213 has determined that the user 105 has fallen asleep. Similarly, the sleep monitoring application 213 may turn on the television 125a and/or the lighting 125b after the sleep monitoring application 213 has determined the user 105 may be about to wake up. The electronic devices may be controlled using existing Bluetooth or Wifi modules of the mobile device 115 or through one or more external components interfaced with the mobile device 115, for example. In some implementations, the electronic devices may be Internet Protocol addressable devices, and may support one or more home automation standards such as Z-WAVE and INSTEON, for example.

It is contemplated that in an implementation, the user 105 may be a baby or child, and the mobile device 115 with the sleep monitoring application 213 may be used to monitor the sleeping of the baby or child.

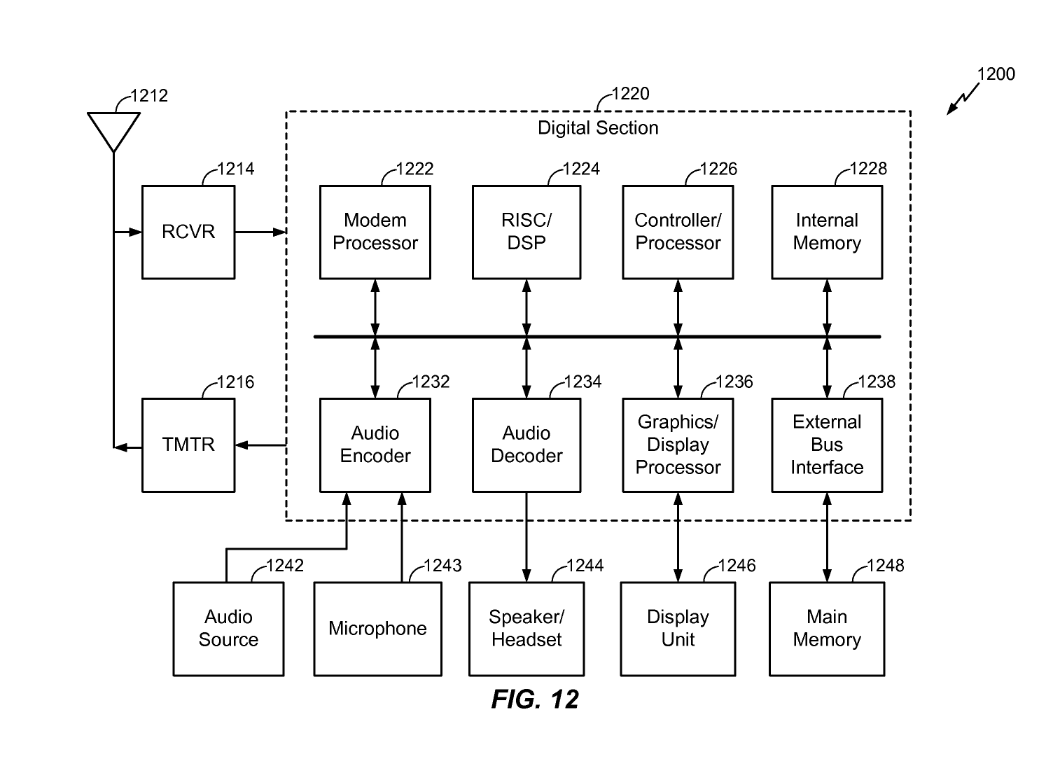

FIG. 2 is an illustration of an example mobile device 115 with a sleep monitoring application 213. The sleep monitoring application 213 may include a variety of components including, but not limited to, a recorder 210, a sound analyzer 220, a sleep cycle identifier 230, an ambient sound engine 240, a sleep disorder identifier 250, an electronic device controller 260, and a report generator 270. The sleep monitoring application 213 may be implemented by a computing device, such as the mobile device 115. The mobile device 115 may include a variety of mobile devices including, but not limited to, the mobile device 1200 illustrated with respect to FIG. 12. The mobile device 115 may include the microphone 116 and the speaker 117. In addition, the mobile device 115 may include an electronic device interface 280 for interfacing with and controlling a variety of electronic devices. The electronic device interface 280 may support Bluetooth or Wifi networking protocols, as well as one or more home automation protocols, for example.

The recorder 210 may collect environmental sound external to the mobile device 115 through the microphone 116. Alternatively or additionally, the environmental sound may be collected by an additional or alternative microphone that is external to the mobile device 115. The collected environmental sound may be stored in a recorded sound storage 215. The collected environmental sound may be stored using a variety of well known sound recording formats and codecs. In some implementations, the recorded sound storage 215 may store the equivalent of one night of sleep for a user which may be discarded after the recording has been processed by the application 213, for example. Alternatively, the recorded sound storage 215 may store multiple nights (or other time periods) of sleep recordings.

The sound analyzer 220 may analyze the collected environmental sound to determine one or more indicators of sleep activity. The indicators of sleep activity may include sounds associated with breathing (breathing regularity, breathing period, etc.), tossing and turning, snoring, sleep talking, teeth grinding, and crying, for example. In some implementations, the indicators of sleep activity may be identified using one or more sound models. The models may be stored in the sound model storage 225, for example. The models may include frequencies and/or “audio fingerprints” associated with indicators of sleep. For example, users may be known to breathe in particular frequency ranges. With respect to snoring and sleep apnea detection, techniques may be used to determine inhale states, vibrations, snoring strengths, pauses, lengths of pauses, etc. The pause state is the result of apnea, as is well known.

In some implementations, the sound analyzer 220 may extract sound features such as mel-frequency cepstral coefficients from the environmental sound and use one or more of the sound models to determine the indicators of sleep activity from the extracted features. The models may be hidden Markov models, for example. Other models may be used.

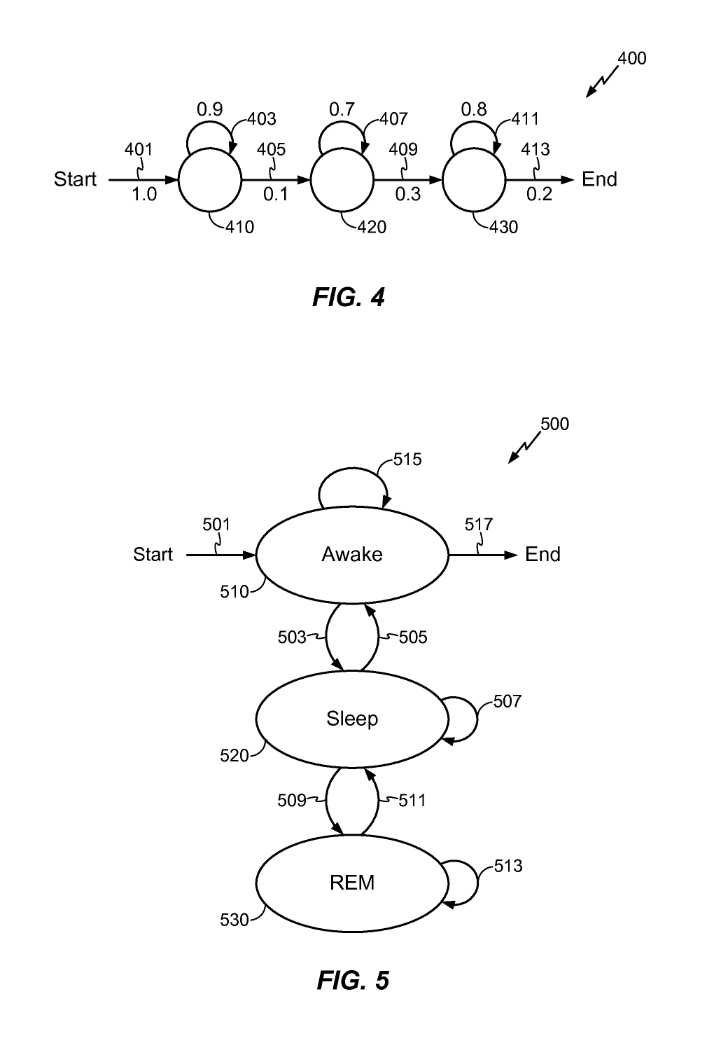

For example, FIG. 4 is an illustration of a state machine 400 implementing a hidden Markov model for detecting an indicator of sleep activity. The state machine 400 has three states 410, 420, and 430, and state transitions 401, 403, 405, 407, 409, 411, and 413. As illustrated, each of the state transitions also has a corresponding probability. The probabilities shown are examples only and any values may be used, depending on the implementation. The sound analyzer 220 may extract mel-frequency cepstral coefficients from the environmental sound and may transition between the states 410, 420, and 430 based on the extracted coefficients. When the sound analyzer 220 exits the state machine 400 by following the transition 413, the sound analyzer 220 may determine that a corresponding indicator of sleep activity has been detected. The particular coefficients corresponding to each transition and the associated probabilities may be part of the sound model storage 225, for example.

In some implementations, the sound analyzer 220 may identify the indicators of sleep activity in real time or near real time. For example, the sound analyzer 220 may identify the indicators of sleep activity as the environmental sound is collected by the recorder 210. Alternatively or additionally, the sound analyzer 220 may identify the indicators of sleep activity after the environmental sound has been collected (e.g., after the user wakes up or at another later time).

The sleep cycle identifier 230 may process the indicators of sleep activity to identify one or more sleep cycles, including times at which the user entered and exited each identified sleep cycle. Typical sleep cycles include stage 1 (drowsiness) that lasts about 5 to 10 minutes, during which time the breathing rate begins to relax; stage 2 (light sleep) in which eye movements stop, heart rate slows, and body temperature decreases; stages 3 and 4 (deep sleep) in which the brain rests; and REM (rapid eye movement) sleep (dream sleep) in which breathing is rapid, irregular, and shallow.

In some implementations, the sleep cycle identifier 230 may identify the sleep cycle(s) based on characteristics of each of the sleep cycles using the indicators of sleep activity. In an implementation, the first stage of sleep is characterized by a reduction in the breathing rate of the user and typically lasts between five to ten minutes. The second through fourth stages of sleep are characterized by further reductions in breathing rate. Thus, by analyzing the indicators of sleep activity, and in particular, the indicators of sleep activity associated with breathing, the sleep cycle identifier 230 may identify the sleep cycle(s). Some or all of the identified sleep cycles may be stored in a sleep cycle identifier storage 235.

The sleep cycle identifier 230 may further consider user feedback to identify the one or more sleep cycles. For example, the sleep cycle identifier 230 may determine that the user has entered a sleep state based on one or more sleep models, and may therefore turn off the television 125a and/or the lighting 125b using the electronic device interface 280. However, the sleep cycle identifier 230 may later determine that the user has reactivated the television 125a and/or the lighting 125b, indicating that the user had not entered a sleep state. Accordingly, the sleep cycle identifier 230 may adjust the sleep model used to determine that the user has entered a sleep state. Other user feedback may be used, such as the user activating the mobile device 115 or generating some other type of audio feedback, for example.

In some implementations the sleep cycle identifier 230 may use one or more hidden Markov models to identify the sleep cycles. For example, FIG. 5 is an illustration of a state machine 500 implementing a hidden Markov model for identifying sleep cycles. The state machine 500 has three states 510, 520, and 530, corresponding to an awake state, a sleep state, and an REM state, respectively. The sleep cycle identifier 230 may transition between the states 510, 520, and 530 by following state transitions 501, 503, 505, 507, 509, 511, 513, 515, and 517 based on the indicators of sleep activity. While not shown, each state transition may have a corresponding probability. The particular probabilities assigned to each state transition may be determined or trained based on observed sleep behaviors of one or more users using a Viterbi algorithm, for example. The sleep cycle identifier 230 may record the time at which a user enters each of the states 510, 520, and 530, as well as the amount of time the user spent in each sleep state.

The ambient sound engine 240 may analyze the environmental sound to determine ambient sound. The ambient sound may be the portion of the environmental sound that is not associated with the user whose sleep is being monitored. The ambient sound may include room sounds such as clock sounds and fan noise, for example. The ambient sound may further include outdoor sounds such as traffic sounds that are audible to the microphone 116. In some implementations, the ambient sound may include the portions of the environmental sound that have not been identified as indicators of sleep activity. The ambient sound may be stored in an ambient sound storage 245.

Similarly to the sound analyzer 220, in some implementations, the ambient sound engine 240 may analyze the collected environmental sound in real time or near real time. Alternatively or additionally, the ambient sound engine 240 may analyze the collected environmental sound after the user has awakened or at some other later time.

The ambient sound engine 240 may correlate the ambient sound with one or more sleep cycles. In some implementations, the ambient sound engine 240 may correlate the ambient sound to identify ambient sound associated with good sleep. Good sleep may be defined as nights or sleep events where the user entered the first sleep stage quickly (e.g., the user having entered a predetermined sleep stage within a predetermined amount of time), where the user achieved a large amount of REM sleep, and/or where the user did not awaken during the night (e.g., the user having slept without awaking for a predetermined amount of time), for example. Other definitions of good sleep may be used. The ambient sound associated with good sleep may be flagged or otherwise indicated in the ambient sound storage 245.

The ambient sound engine 240 may determine if the user is having trouble sleeping (i.e., entering a sleep state), and if so, may play one or more ambient sounds that are associated with good sleep. For example, it may be determined that the user is not sleeping and needs ambient sound assistance if the user has not entered REM sleep within a predetermined amount of time.

The ambient sound may be retrieved from the ambient sound storage 245 and played to the user through the speaker 117 of the mobile device 115. Alternatively or additionally, the ambient sound engine 240 may use the electronic device interface 280 to cause one or more external electronic devices (e.g., in the room with the user) to play the ambient sound. For example, the ambient sound may be played through the television 125a in the room with the user. By playing ambient sound that is associated with good sleep, the user may be soothed into entering a sleep state. The most frequently stored ambient sound in the ambient sound storage 245 may be retrieved and played to assist the user in falling asleep. In an embodiment, the ambient sounds in the ambient sound storage 245 may be given ratings, scores, or other indicators by the user or by the application, for example, to indicate which ambient sound to play for sleep assistance, to indicate which order to play the ambient sounds, and/or to indicate under what conditions a particular ambient sound is to be played and for how long.

The sleep disorder identifier 250 may process the indicators of sleep activity to identify one or more sleep disorders. The sleep disorders may include sleep disorders such as chronic snoring and sleep apnea. Other sleep disorders may also be identified. In some implementations, the sleep disorders may be identified from the indicators of sleep activity using one or more characteristics of the sleep disorders. With respect to chronic snoring, the sleep disorder may be characterized by indicators of sleep activity showing frequent snoring followed by periods of waking With respect to sleep apnea, the sleep disorder may be characterized by the relative lengths of the exhale and inhale actions during breathing and any pauses between the exhale and inhale actions, for example. Any indicators of sleep disorders may be stored in a sleep disorder identifier storage 255.

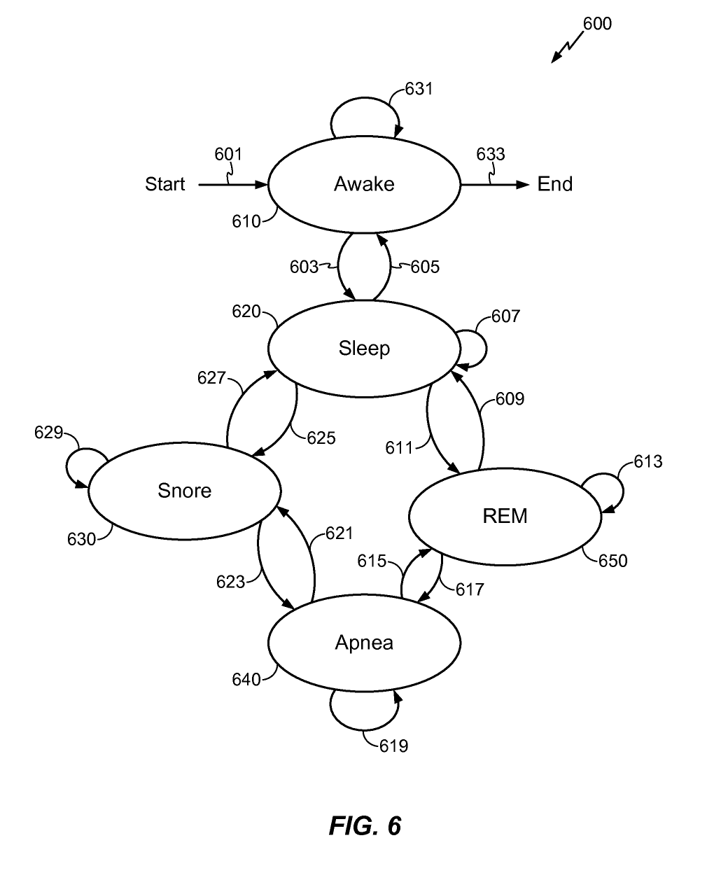

In some implementations, the sleep disorder identifier 250 may use one or more hidden Markov models to identify the sleep disorders. For example, FIG. 6 is an illustration of a state machine 600 implementing a hidden Markov model for identifying sleep disorders. The state machine has five states 610, 620, 630, 640, and 650 corresponding to an awake state, a sleep state, a snore state, an apnea state, and an REM state, respectively. The sleep disorder identifier 250 may transition between the states 610, 620, 630, 640, and 650 by following state transitions 601, 603, 605, 607, 609, 611, 613, 615, 617, 619, 621, 623, 625, 627, 629, 631, and 633 based on the indicators of sleep activity. While not shown, each state transition may have a corresponding probability. The particular probabilities assigned to each state transition may be determined or trained based on observed sleep behaviors of one or more users having one or more known sleep disorders, for example. The sleep disorder identifier 250 may record the time at which a user enters each of the states 630 and 640 in the sleep disorder identifier storage 255 since those states correspond to the sleep disorders of snoring and sleep apnea. The sleep disorder identifier 250 may further record the amount of time that the user spends in each of the states 630 and 640.

The electronic device controller 260 may use the electronic device interface 280 to control one or more electronic devices such as the television 125a and the lighting 125b. Other electronic devices may also be supported such as alarm clocks, radios, fans, and appliances such as coffee makers and toasters, for example. The user may use the sleep monitoring application 213 to select one or more electronic devices that the user would like to have turn on when they are about to wake up or turn off after they have fallen asleep. For example, the user may select that the television 125a be turned on when they are about to wake up, and turned off when they fall asleep.

The electronic device controller 260 may determine that the user is about to wake up. For example, the electronic device controller 260 may determine from the sleep cycle identifier 230 that the user has entered the first sleep stage and has an increasing breathing rate suggesting that the user will wake up soon. Accordingly, the electronic device controller 260 may activate one or more selected electronic devices such as the television 125a and the lighting 125b. In some implementations, the electronic device controller 260 may gradually increase the volume of the television 125a and the lighting 125b to gently wake the user up. The electronic device controller 260 may interface with the one or more electronic devices using the electronic device interface 280. The electronic device interface 280 may support a variety of networking and home automation standards that allow it to interface with the electronic devices that also support such networking and/or home automation standards.

The electronic device controller 260 may determine that the user has fallen asleep, and may then deactivate one or more electronic devices after it has determined that the user has fallen asleep. For example, the electronic device controller 260 may determine from the sleep cycle identifier 230 that the user has entered into a sleep state after being awake. The electronic device controller 260 may then use the electronic device interface 280 to deactivate one or more electronic devices. For example, the electronic device controller 260 may use the electronic device interface 280 to turn off the lighting 125b and the television 125a.

The report generator 270 may generate a sleep report that includes sleep information for the user. The generated sleep report may summarize the previous night's sleep (or any time period of sleep) for the user and may include a variety of information such as a summary or graph of the identified sleep cycles that the user entered along with the approximate time and duration of each cycle, for example. The report may include alerts related to any sleep disorders that are identified for the user. In an implementation, the report generator 270 may generate the report using the identified sleep cycles from the sleep cycle identifier storage 235 and the identified sleep disorders from the sleep disorder identifier storage 255. The report may comprise information directed to particular sound events that may have occurred during the time period for sleep. Such information may be directed to when and/or for how long the user grinded their teeth and/or snored, when the bedroom door was opened or closed, when a baby cried, etc., for example. The sound analyzer 220 and/or the ambient sound engine 240 may analyze the environmental sound to determine these types of ambient sounds (e.g., using comparisons with predetermined and stored sounds associated with these types of events), and provide the information to the report generator 270.

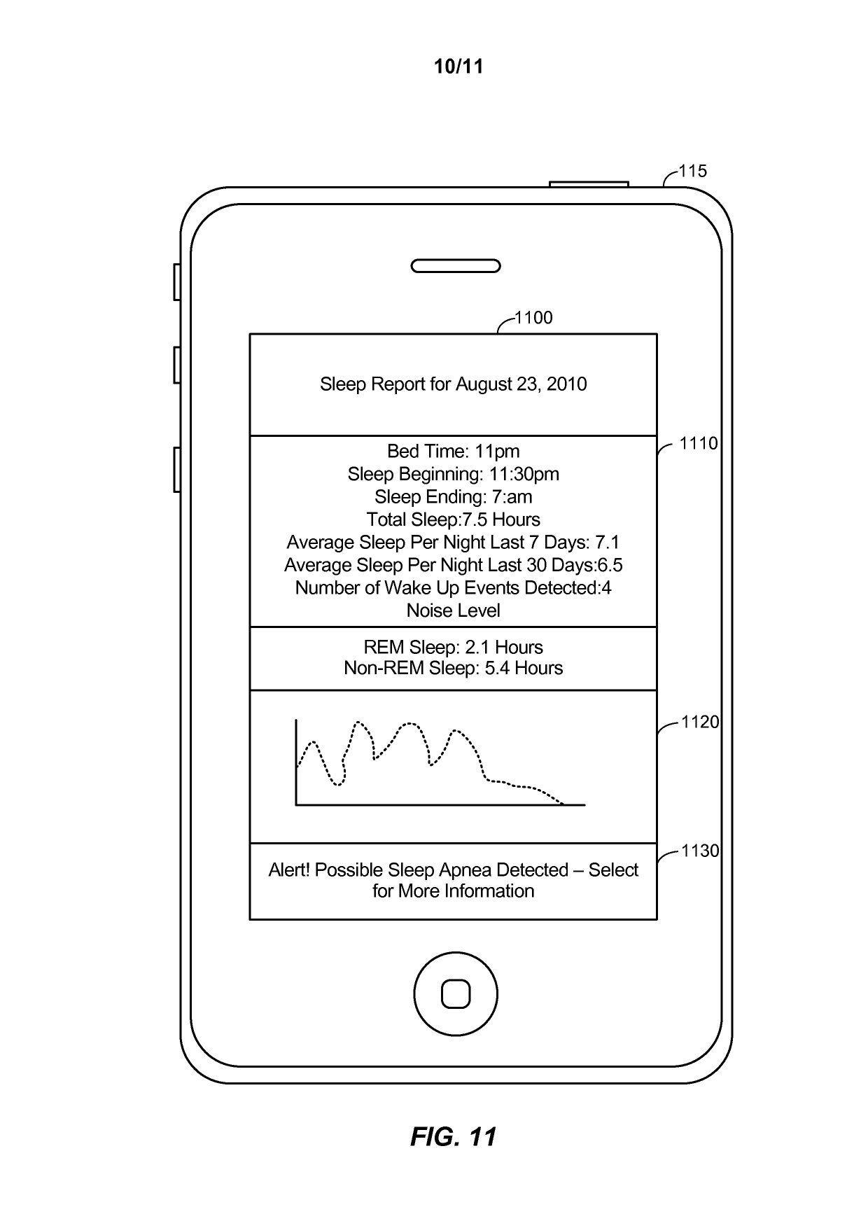

The generated sleep report may be presented to the user on the display of the mobile device 115, for example, when the user wakes up. Alternatively or additionally, the user may use the sleep monitoring application 213 to view one or more sleep reports at the user's convenience. The user may view sleep reports for a variety of time periods including a report for the previous night, week, or year, for example. An example sleep report is described further with respect to FIG. 11.

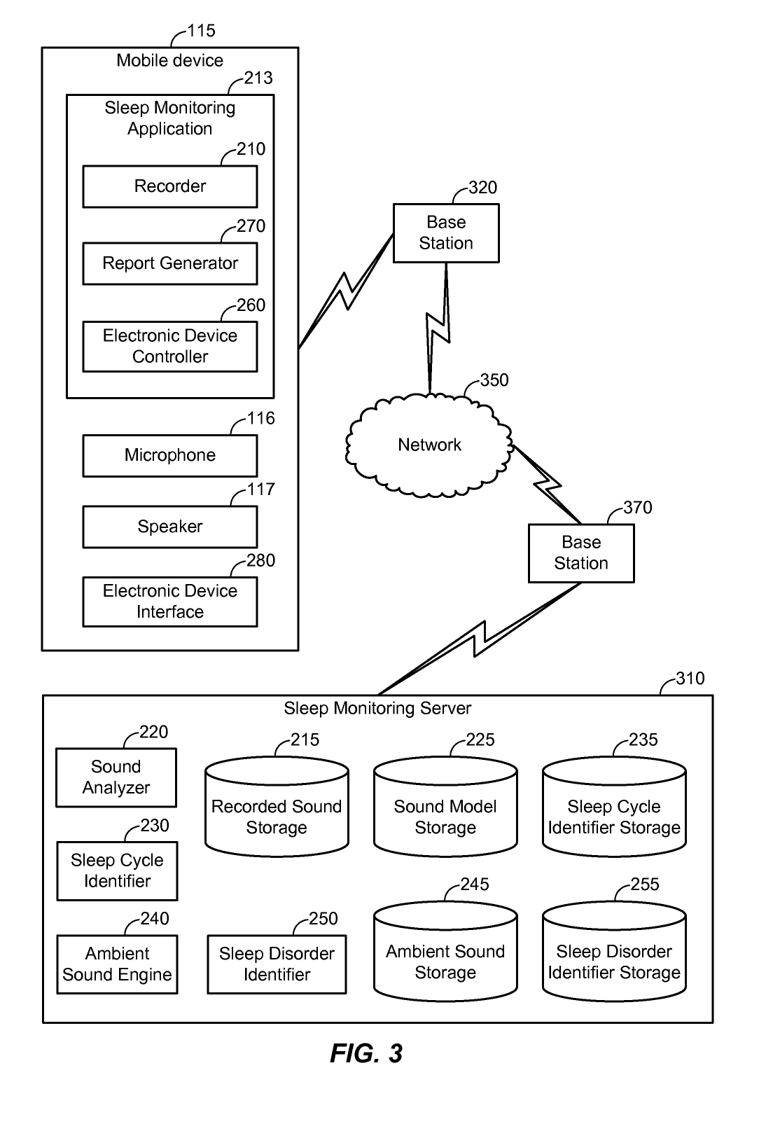

FIG. 3 is an illustration of an example mobile device 115 with sleep monitoring application 213 in communication with a sleep monitoring server 310. In contrast with FIG. 2, some of the components of the sleep monitoring application 213 have been moved to the sleep monitoring server 310. In particular, in this example, the sound analyzer 220, the sleep cycle identifier 230, the ambient sound engine 240, and the sleep disorder identifier 250 have been moved to the sleep monitoring server 310. By moving some or all of the components to the sleep monitoring server 310, mobile devices with less resources or processing capabilities may be able to execute the sleep monitoring application 213, for example.

The recorder 210 may collect environmental sound. The collected environmental sound may be transmitted by the mobile device 115 to a base station 320. The base station 320 may communicate with a network 350 which may generally include any other portions of cellular, packet switching, circuit switching, public switched telephone network (PSTN), etc., networks used to enable the mobile device 115 to communicate with other mobile or fixed devices, computers, servers, etc., located anywhere. The network 350, for example, may communicate with a base station 370 that may be in communication with the sleep monitoring application server 310. The sound analyzer 220, the sleep cycle identifier 230, the ambient sound engine 240, and the sleep disorder identifier 250 at the sleep monitoring server 310 may process the environmental sound similar to that described with respect to FIG. 2.

In an implementation, after processing, or at the request of the sleep monitoring application 213, the sleep monitoring server 310 may transmit one or more identifiers of sleep cycles and/or sleep disorders back to the mobile device 115 via the base station 370. The mobile device 115 may receive the one or more identifiers of sleep cycles and/or sleep disorders via the base station 320 and the report generator 270 may generate a sleep report from the received one or more identifiers. The ambient sound may be similarly transmitted to the mobile device 115 by the sleep monitoring server 310 and played back to the user by the sleep monitoring application 213 of the mobile device 115.

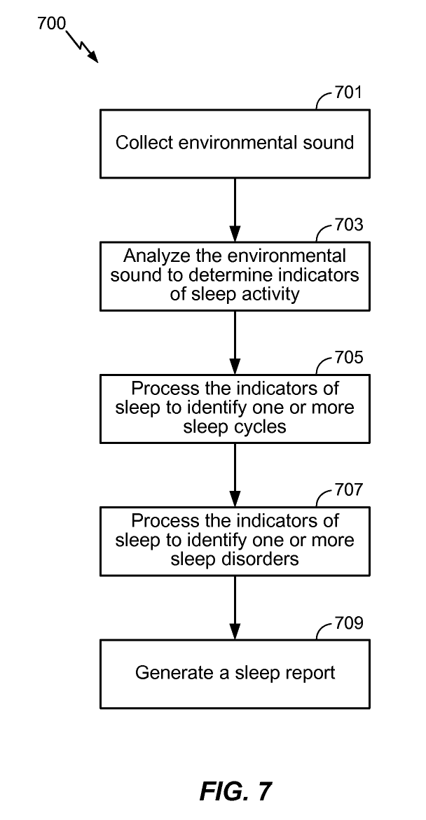

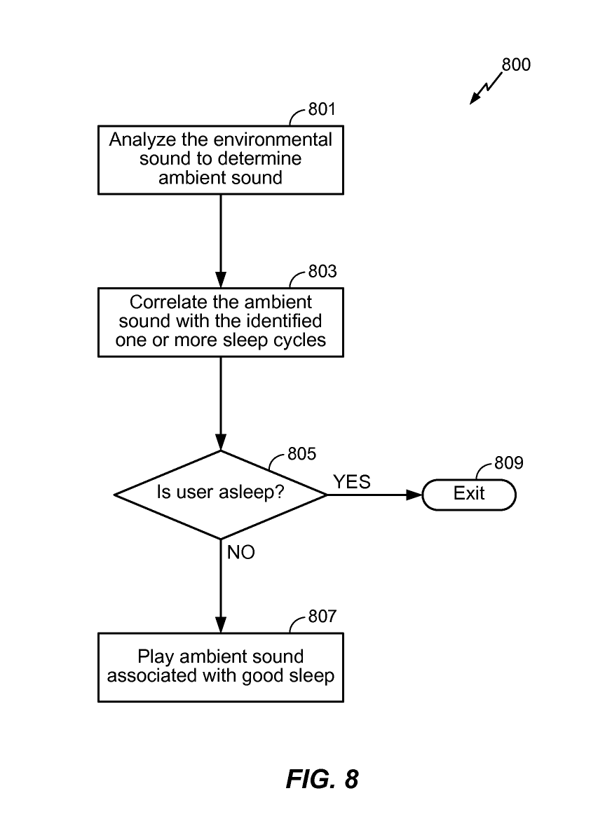

FIG. 7 is an operational flow of an implementation of a method 700 for generating a sleep report using collected environmental sound. The method 700 may be implemented by one or more of a sleep monitoring application 213 of a mobile device 115 and a sleep monitoring server 310.

The method 700 may commence at 701, for example, when the recorder 210 of the sleep monitoring application 213 of the mobile device 115, begins collecting environmental sound. For example, a user may have activated the sleep monitoring application 213 on their mobile device 115 and may have gone to sleep for the night. The sleep monitoring application 213 may use the microphone 116 of the mobile device 115 to collect environmental sound from a room where the user is sleeping. In implementations using a sleep monitoring server 310, some or all of the collected environmental sound may be transmitted to the sleep monitoring server 310.

At 703, the collected environmental sound is analyzed to determine indicators of sleep activity. The collected environmental sound may be analyzed by the sound analyzer 220 of the sleep monitoring application 213 or sleep monitoring server 310. In some implementations, the environmental sound may be analyzed using one or more sound models from the sound model storage 225. The indicators of sleep activity may be sounds relating to breathing, snoring, or activity of the user being monitored, for example.

At 705, the indicators of sleep activity are processed to identify one or more sleep cycles. The indicators of sleep activity may be processed by the sleep cycle identifier 230 of the sleep monitoring application 213 or sleep monitoring server 310. In some implementations, the indicators of sleep activity may be processed using characteristics of one more sleep cycles. For example, the different stages of sleep may be identified based on the changes of the breathing rate of the user. The identified sleep cycles may be stored in the sleep cycle identifier storage 235 along with a time the user exited and entered each identified sleep cycle.

At 707, the indicators of sleep activity are processed to identify one or more sleep disorders. The indicators of sleep activity may be processed by the sleep disorder identifier 250 of the sleep monitoring application 213 or sleep monitoring server 310. In some implementations, the indicators of sleep activity may be processed using characteristics of one more sleep disorders. For example, apnea may be detected based on breathing characteristics of the user. The identified sleep disorders may be stored in the sleep disorder identifier storage 255.

At 709, a sleep report may be generated. The sleep report may be generated by the report generator 270 of the sleep monitoring application 213 using the indicators of sleep cycles and the indicators of sleep disorders. The report may be displayed to the user on the display of the mobile device 115. In implementations using the sleep monitoring server 310, the indicators of sleep cycles and indicators of sleep disorders may be transmitted to the report generator 270 of the sleep monitoring application 213. The sleep report may provide a summary of the sleep of the user for a variety of time periods including the sleep of a previous night, week, year, etc. The sleep report may alert the user to any detected sleep disorders. The report may include information directed to particular sound events that may have occurred during the time period(s) (e.g., when and/or for how long the user grinded their teeth and/or snored, when the bedroom door was opened or closed, when a baby cried, etc.). An example sleep report is illustrated with respect to FIG. 11.

FIG. 8 is an operational flow of an implementation of a method 800 for determining ambient sound associated with one or more sleep cycles and playing the determined ambient sound to a user when it is determined that the user cannot sleep or is having difficulty falling asleep. The method 800 may be implemented by a sleep monitoring application 213 of a mobile device 115 and/or a sleep monitoring server 310, for example.

The method 800 may commence at 801, for example, when the ambient sound engine 240 of the sleep monitoring application 213 of the mobile device 115 or the sleep monitoring server 310, analyzes the environmental sound to determine ambient sound. The environmental sound may be the environmental sound collected in method 700. The ambient sound may comprise some or all of the sound that is not attributable to the user being monitored (e.g., sounds made by various items in the room such as clocks or fans, and traffic or nature sounds, etc.).

At 803, the ambient sound is correlated with the identified one or more sleep cycles to identify ambient sound associated with good sleep. The ambient sound may be correlated by the ambient sound engine 240. The ambient sound may be correlated with the identified one or more sleep cycles collected in a single sleep session of the user, or for a specified period of time such as a week, month, or year, for example. A particular ambient sound may be considered to be associated with good sleep if it coincides with a large number of sleep cycles. Alternatively or additionally, an ambient sound may be considered to be associated with good sleep if it coincides with extended REM sleep cycles, for example. The ambient sound that is associated with good sleep may be stored in the ambient sound storage 245.

At 805, at some later time, a determination is made as to whether the user is asleep. The determination may be made by the sleep cycle identifier 230 using the one or more indicators of sleep. For example, a user may later use the sleep monitoring application 213 to monitor their sleep. The environmental sound may be collected, and based on the indicators of sleep activity from the environmental sound, the sleep cycle identifier 230 may determine whether the user has fallen asleep. If the user is asleep, then the method 800 may exit at 809. Otherwise, the method 800 may continue at 807.

At 807, the ambient sound that is associated with good sleep is retrieved from storage and played to the user. The ambient sound may be played by the ambient sound engine 240 to the user through the speaker 117 of the mobile device 115. In implementations where the ambient sound engine 240 is part of the sleep monitoring server 310, the ambient sound may be transmitted to the mobile device 115 and played by the mobile device 115 through the speaker 117. Alternatively or additionally, the ambient sound may be played to the user through one or more electronic devices located in a room where the user is trying to sleep.

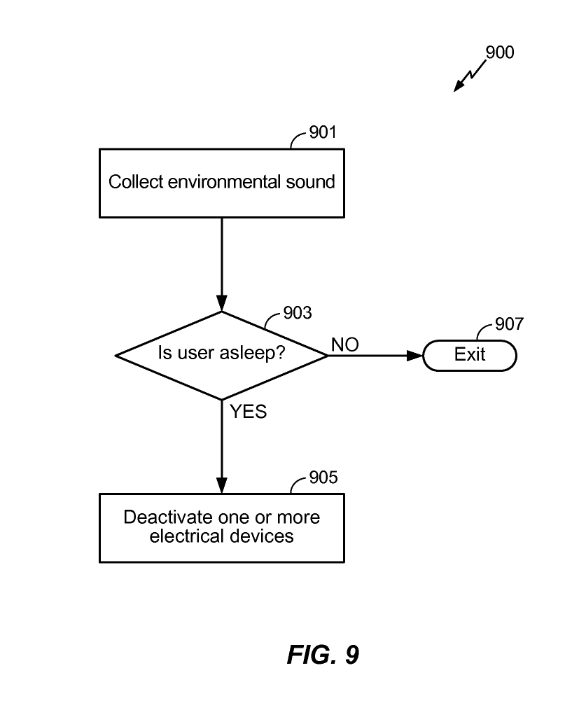

FIG. 9 is an operational flow of an implementation of a method 900 for determining if a user is asleep and deactivating one or more electronic devices if the user is asleep. The method 900 may be implemented by a sleep monitoring application 213 of a mobile device 115 and/or a sleep monitoring server 310.

The method 900 may commence at 901, for example, when the recorder 210 of the sleep monitoring application 213 of the mobile device 115 collects environmental sound. In implementations using a sleep monitoring server 310, some or all of the collected environmental sound may be transmitted to the sleep monitoring server 310.

At 903, a determination is made as to whether the user is asleep. The determination may be made by the sleep cycle identifier 230 using one or more indicators of sleep. If the user is not asleep, then the method 900 may exit at 907. Otherwise, the method 900 may continue at 905.

At 905, one or more electronic devices may be deactivated. The one or more devices may be deactivated by the electronic device controller 260. For example, the electronic device controller 260 may use the electronic device interface of the mobile device 115 to turn off the television 125a or the lighting 125b in the room where the user is sleeping.

In an implementation, when it has been determined that the user is sleeping or has entered a particular sleep stage, audio and/or other content may be retrieved from storage or otherwise obtained and played from the mobile device or another electronic device. Such audio and/or other content may include music or other audio or multimedia programming or advertisements, for example.

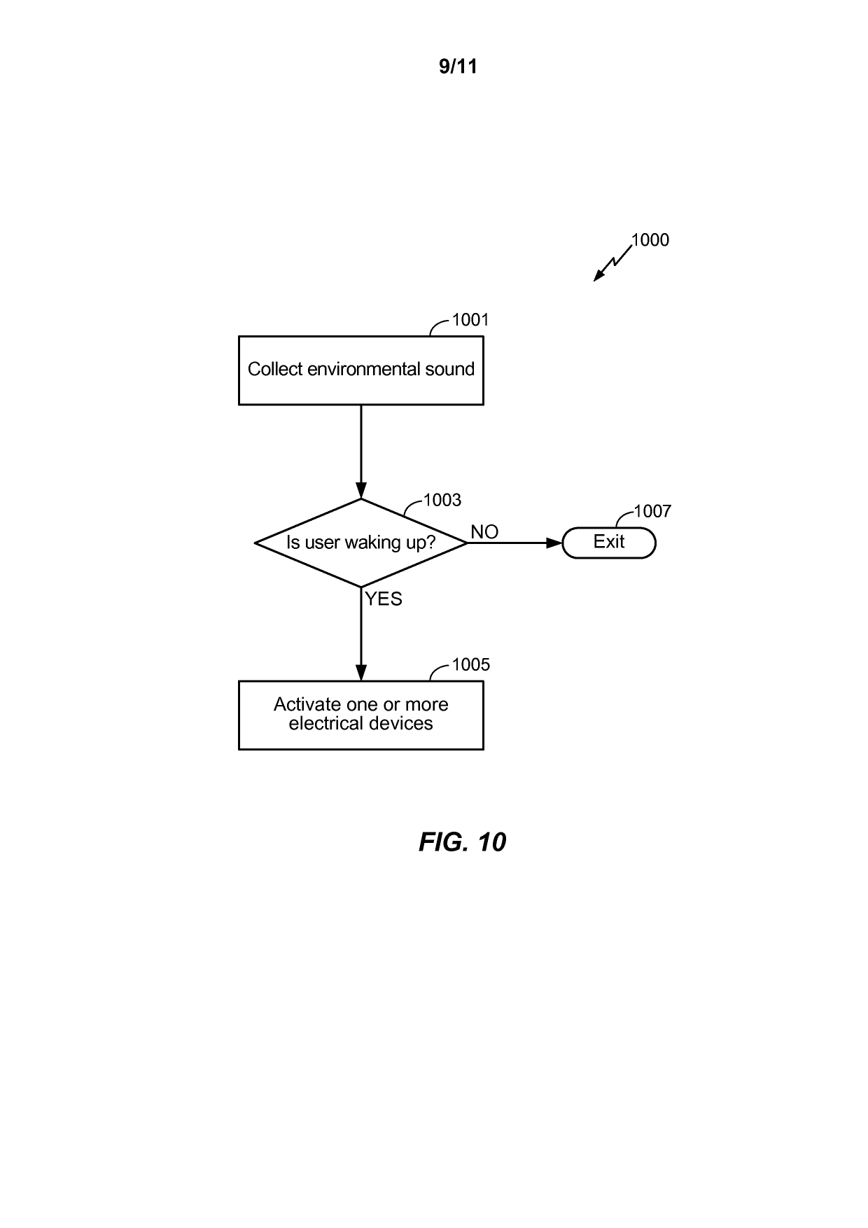

FIG. 10 is an operational flow of an implementation of a method 1000 for determining is a user is going to wake up (e.g., is about to wake up or will be waking up shortly) and activating one or more electronic devices if the user is going to wake up. The method 1000 may be implemented by a sleep monitoring application 213 of a mobile device 115 and/or a sleep monitoring server 310, for example.

The method 1000 may commence at 1001, for example, when the recorder 210 of the sleep monitoring application 213 of the mobile device 115, collects environmental sound.

At 1003, a determination is made as to whether the user is about to wake up. The determination may be made by the sleep cycle identifier 230 using one or more indicators of sleep. If the user is not waking up, then the method 1000 may exit at 1007. Otherwise, the method 1000 may continue at 1005.

At 1005, one or more electronic devices may be activated. The one or more devices may be activated by the electronic device controller 260. For example, the electronic device controller 260 may use the electronic device interface of the mobile device 115 to turn on the television 125a or the lighting 125b in the room where the user is sleeping.

FIG. 11 is an illustration of an example sleep report 1100. The sleep report 1100 may be displayed (e.g., to the user) on a display of the mobile device 115 or on any other display device. The sleep report 1100 may include one or more statistics 1110. The statistics 1110 may include a variety of statistics about the sleep of the user. The statistics 1110 may include the total amount of sleep achieved by the user for a night, the average amount of sleep the user achieves a night over various time periods, and the total amount of time the user spends in each sleep state, for example. Any one of a variety of sleep statistics may be supported. The user may select the particular statistics 1110 that they would like to view on the sleep report 1100 using the sleep monitoring application 213, for example.

The sleep report 1100 may further include one or more graphs 1120. The graph 1120 may provide a graphical view of one or more of the statistics 1110. For example, the graph 1120 may be a graph of the amount of time spent in each sleep stage for a previous night. The user may select the particular graphs 1120 that they would like to view on the sleep report 1100 using the sleep monitoring application 213, for example.

The sleep report 1100 may further include one or more alerts 1130. The alerts 1130 may alert the user to any detected sleep disorders. The alerts 1130 may be displayed in such a way as to get the attention of the user and may provide advice for the user based on the detected sleep disorder.

FIG. 12 shows a block diagram of a design of an example mobile device 1200 in a wireless communication system. Mobile device 1200 may be a cellular phone, a terminal, a handset, a personal digital assistant (PDA), a wireless modem, a cordless phone, etc. The wireless communication system may be a Code Division Multiple Access (CDMA) system, a Global System for Mobile Communications (GSM) system, etc.

Mobile device 1200 is capable of providing bidirectional communication via a receive path and a transmit path. On the receive path, signals transmitted by base stations are received by an antenna 1212 and provided to a receiver (RCVR) 1214. Receiver 1214 conditions and digitizes the received signal and provides samples to a digital section 1220 for further processing. On the transmit path, a transmitter (TMTR) 1216 receives data to be transmitted from digital section 1220, processes and conditions the data, and generates a modulated signal, which is transmitted via antenna 1212 to the base stations. Receiver 1214 and transmitter 1216 may be part of a transceiver that may support CDMA, GSM, etc.

Digital section 1220 includes various processing, interface, and memory units such as, for example, a modem processor 1222, a reduced instruction set computer/digital signal processor (RISC/DSP) 1224, a controller/processor 1226, an internal memory 1228, a generalized audio encoder 1232, a generalized audio decoder 1234, a graphics/display processor 1236, and an external bus interface (EBI) 1238. Modem processor 1222 may perform processing for data transmission and reception, e.g., encoding, modulation, demodulation, and decoding. RISC/DSP 1224 may perform general and specialized processing for mobile device 1200. Controller/processor 1226 may direct the operation of various processing and interface units within digital section 1220. Internal memory 1228 may store data and/or instructions for various units within digital section 1220.

Generalized audio encoder 1232 may perform encoding for input signals from an audio source 1242, a microphone 1243, etc. Generalized audio decoder 1234 may perform decoding for coded audio data and may provide output signals to a speaker/headset 1244. Graphics/display processor 1236 may perform processing for graphics, videos, images, and texts, which may be presented to a display unit 1246. EBI 1238 may facilitate transfer of data between digital section 1220 and a main memory 1248.

Digital section 1220 may be implemented with one or more processors, DSPs, microprocessors, RISCs, etc. Digital section 1220 may also be fabricated on one or more application specific integrated circuits (ASICs) and/or some other type of integrated circuits (ICs).

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof

The sleep monitoring techniques described herein may be implemented by various means. For example, these techniques may be implemented in hardware, firmware, software, or a combination thereof. Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein may be implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For a firmware and/or software implementation, the techniques may be embodied as instructions stored on a computer-readable medium, such as random access memory (RAM), read-only memory (ROM), non-volatile random access memory (NVRAM), programmable read-only memory (PROM), electrically erasable

PROM (EEPROM), FLASH memory, compact disc (CD), magnetic or optical data storage device, or the like. The instructions may be executable by one or more processors and may cause the processor(s) to perform certain aspects of the functionality described herein.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer readable medium. Disk and disc, as used herein, includes CD, laser disc, optical disc, digital versatile disc (DVD), floppy disk and blu-ray disc where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for sleep monitoring, comprising:
collecting environmental sound at a mobile device;
analyzing the environmental sound, by the mobile device, to determine one or more indicators of sleep activity;
processing the one or more indicators of sleep activity, by the mobile device, to identify one or more sleep cycles; and
generating a sleep report by the mobile device using the identified one or more sleep cycles.

2. The method of claim 1, wherein analyzing the environmental sound to determine indicators of sleep activity uses one or more sound models.

3. The method of claim 2, wherein the sound models comprise techniques to determine at least one of inhale states, vibrations, snoring strengths, pauses, or lengths of pauses.

4. The method of claim 1, wherein the indicators of sleep activity comprise sound associated with breathing and sound associated with body movement.

5. The method of claim 1, further comprising analyzing the environmental sound to determine ambient sound.

6. The method of claim 5, further comprising correlating the ambient sound with the one or more sleep cycles to identify ambient sound associated with a user having entered a predetermined sleep stage within a predetermined amount of time or with the user having slept without awaking for a predetermined amount of time.

7. The method of claim 6, further comprising:
determining that a user is not asleep using the one or more identified sleep cycles; and
if it is determined that the user is not asleep, causing the identified ambient sound to play.

8. The method of claim 7, wherein causing the identified ambient sound to play comprises one of causing the mobile device to play the ambient sounds or causing an electronic device external to the mobile device to play the ambient sound.

9. The method of claim 1, further comprising:
determining that a user is asleep using the one or more identified sleep cycles; and
if it is determined that the user is asleep, disabling one or more electronic devices.

10. The method of claim 1, further comprising processing the one or more indicators of sleep activity to identify one or more sleep disorders.

11. The method of claim 1, further comprising:
determining that a user is about to awaken using the one or more identified sleep cycles; and
if it is determined that the user is about to awaken, enabling one or more electronic devices.

12. The method of claim 11, wherein the one or more electronic devices includes one or more of a television, a radio, or a lighting device.

13. An apparatus for sleep monitoring, comprising:
means for collecting environmental sound;
means for analyzing the environmental sound to determine one or more indicators of sleep activity;
means for processing the one or more indicators of sleep activity to identify one or more sleep cycles; and
means for generating a sleep report using the identified one or more sleep cycles.

14. The apparatus of claim 13, wherein the means for analyzing the environmental sound to determine indicators of sleep activity comprises means for analyzing the environmental sound using one or more sound models.

15. The apparatus of claim 14, wherein the sound models comprise techniques to determine at least one of inhale states, vibrations, snoring strengths, pauses, or lengths of pauses.

16. The apparatus of claim 13, wherein the indicators of sleep activity comprise sound associated with breathing and sound associated with body movement.

17. The apparatus of claim 13, further comprising means for analyzing the environmental sound to determine ambient sound.

18. The apparatus of claim 17, further comprising means for correlating the ambient sound with the one or more sleep cycles to identify ambient sound associated with a user having entered a predetermined sleep stage within a predetermined amount of time or with the user having slept without awaking for a predetermined amount of time.

19. The apparatus of claim 18, further comprising:
means for determining that a user is not asleep using the one or more identified sleep cycles; and
means for causing the identified ambient sound to play if it is determined that the user is not asleep.

20. The apparatus of claim 19, wherein causing the identified ambient sound to play comprises one of causing the apparatus to play the ambient sounds or causing an electronic device external to the apparatus to play the ambient sound.

21. The apparatus of claim 13, further comprising:
means for determining that a user is asleep using the one or more identified sleep cycles; and
means for disabling one or more electronic devices if it is determined that the user is asleep.

22. The apparatus of claim 13, further comprising means for processing the one or more indicators of sleep activity to identify one or more sleep disorders.

23. The apparatus of claim 13, further comprising:
means for determining that a user is about to awaken using the one or more identified sleep cycles; and
means for enabling one or more electronic devices if it is determined that the user is about to awaken.

24. The apparatus of claim 23, wherein the one or more electronic devices includes one or more of a television, a radio, or a lighting device.

25. A computer-readable medium comprising instructions that cause a computer to:
collect environmental sound;
analyze the environmental sound to determine one or more indicators of sleep activity;
process the one or more indicators of sleep activity to identify one or more sleep cycles; and
generate a sleep report using the identified one or more sleep cycles.

26. The computer-readable medium of claim 25, wherein analyzing the environmental sound to determine indicators of sleep activity uses one or more sound models.

27. The computer-readable medium of claim 26, wherein the sound models comprise techniques to determine at least one of inhale states, vibrations, snoring strengths, pauses, or lengths of pauses.

28. The computer-readable medium of claim 25, wherein the indicators of sleep activity comprise sound associated with breathing and sound associated with body movement.

29. The computer-readable medium of claim 25, further comprising computer-executable instructions that cause the computer to analyze the environmental sound to determine ambient sound.

30. The computer-readable medium of claim 29, further comprising computer-executable instructions that cause the computer to correlate the ambient sound with the one or more sleep cycles to identify ambient sound associated with a user having entered a predetermined sleep stage within a predetermined amount of time or with the user having slept without awaking for a predetermined amount of time.

31. The computer-readable medium of claim 30, further comprising computer-executable instructions that cause the computer to:
determine that a user is not asleep using the one or more identified sleep cycles; and
if it is determined that the user is not asleep, cause the identified ambient sound to play.

32. The computer-readable medium of claim 31, wherein causing the identified ambient sound to play comprises one of causing the computer to play the ambient sounds or causing an electronic device external to the computer to play the ambient sound.

33. The computer-readable medium of claim 25, further comprising computer-executable instructions that cause the computer to:
determine that a user is asleep using the one or more identified sleep cycles; and
if it is determined that the user is asleep, disable one or more electronic devices.

34. The computer-readable medium of claim 25, further comprising processing the one or more indicators of sleep activity to identify one or more sleep disorders.

35. The computer-readable medium of claim 25, further comprising computer-executable instructions that cause the computer to:
determine that a user is about to awaken using the one or more identified sleep cycles; and
if it is determined that the user is about to awaken, enable one or more electronic devices.

36. The computer-readable medium of claim 35, wherein the one or more electronic devices includes one or more of a television, a radio, or a lighting device.

37. An apparatus for sleep monitoring, comprising:
a recorder for collecting environmental sound;
a sound analyzer for analyzing the environmental sound to determine one or more indicators of sleep activity;
a sleep cycle identifier for processing the one or more indicators of sleep activity to identify one or more sleep cycles; and
a report generator for generating a sleep report using the identified one or more sleep cycles.

38. The apparatus of claim 37, wherein analyzing the environmental sound to determine indicators of sleep activity uses one or more sound models.

39. The apparatus of claim 38, wherein the sound models comprise techniques to determine at least one of inhale states, vibrations, snoring strengths, pauses, or lengths of pauses.

40. The apparatus of claim 37, wherein the indicators of sleep activity comprise sound associated with breathing and sound associated with body movement.

41. The apparatus of claim 37, further comprising an ambient sound engine for analyzing the environmental sound to determine ambient sound.

42. The apparatus of claim 41, wherein the ambient sound engine correlates the ambient sound with the one or more sleep cycles to identify ambient sound associated with a user having entered a predetermined sleep stage within a predetermined amount of time or with the user having slept without awaking for a predetermined amount of time.

43. The apparatus of claim 42, wherein the ambient sound engine further:
determines that a user is not asleep using the one or more identified sleep cycles; and
if it is determined that the user is not asleep, causes the identified ambient sound to play.

44. The apparatus of claim 43, wherein causing the identified ambient sound to play comprises one of causing the apparatus to play the ambient sounds or causing an electronic device external to the apparatus to play the ambient sound.

45. The apparatus of claim 37, further comprising an electronic device controller for:
determining that a user is asleep using the one or more identified sleep cycles; and
if it is determined that the user is asleep, disabling one or more electronic devices.

46. The apparatus of claim 37, further comprising a sleep disorder identifier for processing the one or more indicators of sleep activity to identify one or more sleep disorders.

47. The apparatus of claim 37, further comprising an electronic device controller for:
determining that a user is about to awaken using the one or more identified sleep cycles; and
if it is determined that the user is about to awaken, enabling one or more electronic devices.

48. The apparatus of claim 47, wherein the one or more electronic devices includes one or more of a television, a radio, or a lighting device.

49. The apparatus of claim 37, wherein the sleep report comprises information directed to a plurality of sound events.
